(19) United States
(12) Patent Application Publication
(10) Pub. No.: US 2011/0047845 A1
(43) Pub. Date: Mar. 3, 2011

(54) Device for Removably Mounting a Label on a Surroundable Surface

(76) Inventor: Peter W. BARILE, Morristown, TN (US)

(21) Appl. No.: 12/547,186

(22) Filed: Aug. 25, 2009

(51) Int. Cl. G09F 3/18

(52) U.S. Cl. 40/658; 40/660

(57) ABSTRACT

A device for removably mounting a label proximate a surroundable member such as a handle of a stackable chair. The device includes a body member having a first panel portion adapted to carry a label and an opposite second panel portion. Each of the first and second panel portions define inboard and outboard sides. A flexible portion is joined to and extends between the inboard sides of the panel portions. The flexible portion is adapted to flex around the surroundable member between a wrapped configuration and an unwrapped configuration. The second panel portion is releasably securable proximate the first panel portion in the wrapped configuration.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

This invention relates to a device for nondestructively and removably securing a label proximate an elongated surroundable member, such as the handle on the back of a stackable chair.

2. Description of the Related Art

Numerous occasions arise in which it is desirable to affix a label, card, or similar display device (hereinafter “label”) proximate a surroundable surface, such as an elongated member, such that indicia marked on the label is visible from a distance to the article. For instance, in the organization and arrangement of multiple similar objects, such as the placement of portable, foldable, stackable, or nestable chairs (hereinafter “chairs”), it is often desirable to place a label on a surroundable surface of the chair visible to an observer when the chairs are arranged proximate one another, in order to assist a user in identifying the chair and distinguishing the chairs from each other. More specifically, in the arrangement of like chairs in arrays or other patterns, such as in theater arrangement or arrangement of audience seating of chairs, it is often desirable to affix a label having indicia marked thereon to a portion of the chair visible to an observer. Often, the indicia can be identification indicia, such as row and seat number indicia or other identification indicia to designate which chair a guest is to occupy when seating is reserved. In other instances, indicia marked on the label serve to assist a user in counting, organizing, or otherwise maintaining and/or organizing the foldable or nestable chairs.

It is known in the art to affix a label on a member of a chair using a permanent or semi-permanent fastener such as adhesive, screws, or the like. However, a label affixed to an object, such as a foldable or nestable chair, is often considered unsightly or otherwise disruptive to the natural use or enjoyment of the object, and permanent or semi-permanent fasteners are often difficult to remove or require partial destruction of the chair member to remove. For example, removing adhesive-backed labels is time consuming and difficult and can often leave an unsightly residue build-up on the chair. Attaching a label to a chair member by screws, nails or other such fasteners requires creating nail or screw holes in the chair member, which remain visible and are unsightly upon removal of the label. For these reasons, non-adhesive paper or plastic labels secured about a surroundable member of the chair by string, cord, or the like (hereinafter “string”) are generally preferred since they can be easily removed when the chair is in use and replaced during maintenance and storage of the chair. Such non-adhesive paper or plastic labels can also easily be replaced if they become damaged or if the information indicated on the label becomes outdated. However, the string securing the non-adhesive paper or plastic labels proximate the surroundable chair member often allows the label to swing freely proximate the chair, thereby allowing the indicia marked on the label to be obscured by the free movement of the label. Accordingly, there is a need for a device to allow nondestructive and removable fastening of a label proximate a surroundable member of an object, such as a handle of a chair or other such object, and to maintain visibility of the fastened label.

### BRIEF SUMMARY OF THE INVENTION

A device for removably mounting a label on a surroundable surface is disclosed. The device includes a body member defining a substantially planar geometry. The body member includes a first end panel portion and an opposite second end panel portion. The first and second end panel portions each define a first surface and an opposite second surface, as well as an outboard side and an opposite inboard side. At least one of the first and second end panel portion first surfaces defines at least one engaging member adapted to receive and engage a label. A clip is anchored to and projects outwardly from the first end panel portion second surface. The second end panel portion includes a post which is anchored to and projects outwardly from the second end panel portion second surface.

The body further includes a central portion which is interposed between and joined to respective inboard sides of the first and second end panel portions. The central portion is flexible for engaging and at least partially wrapping about the surroundable surface. The post is adapted for releasable interconnection with the clip when the body member is at least partially wrapped about the surroundable surface to secure the device in removable wrapping relationship to the surroundable surface.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of the device of the present invention, and depicting various features of the invention;

FIG. 2 is a cross-sectional view of the device depicted in FIG. 1 and taken generally along the line 2-2 of FIG. 1;

FIG. 3 is a perspective view of the embodiment of the invention depicted in FIG. 1, and depicting the device as it appears when closed about a surroundable surface; and

FIG. 4 depicts the device of FIG. 3 in the wrapped position about a surroundable top handle of a chair.

### DETAILED DESCRIPTION OF THE INVENTION

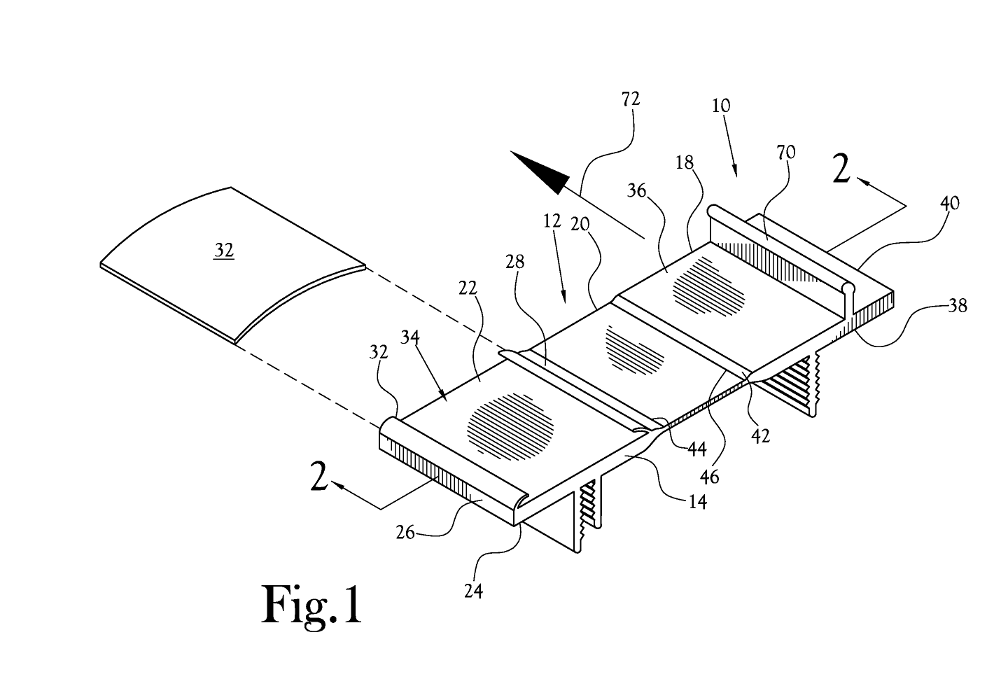

A device for removably mounting a label on a surroundable surface is described in detail and illustrated by the accompanying description and figures. Referring to FIG. 1, the device for securing a label, or device 10, includes generally a planar body member 12 having a first end panel portion 14 for carrying and displaying a label 16, an opposite second end panel portion 18, and a flexible central portion 20 interposed therebetween. As will be discussed further hereinbelow, the first and second end panel portions 14, 18 cooperate to define a releasable fastener adapted to releasably secure the first and second end panel portions proximate one another so as to allow the body member 12 to engage and wrap about a surroundable member to secure and display the label proximate the surroundable member.

In the illustrated embodiment, the first end panel portion 14 defines a substantially rectangular shape having a first surface 22 and an opposite second surface 24 with an outboard end 26 and an opposite inboard end 28. Suitable engagement means are provided along the first surface 22 of the first end panel portion 14 for engaging and carrying the label 16 along the first end panel portion first surface 22 to display at least a portion of the label 16 along the first end panel portion first surface 22. In the illustrated embodiment, the engagement means includes a pair of engaging members 30, 32 extending along the inboard and outboard ends 28, 26, of the first end panel portion 14 in a configuration overhanging the first surface 22 of the first end panel portion 14. The engaging members 30, 32 cooperate with the first end panel portion first surface 22 to define a channel 34 which is sized to receive the label 16 and to hold the label 16 substantially flush with the first end panel portion first surface 22. In another embodiment (not shown), a plurality of engaging members are provided along each edge of the rectangular first end panel portion 14 in a configuration overhanging the first surface 22 of the first end panel portion 14. In this embodiment, the engaging members cooperate with the first end panel portion first surface 22 to form a receptacle for receiving a label therein. In yet another embodiment, a single engagement member is provided in a configuration overhanging and biased toward the first end panel portion first surface 22. In this embodiment, the engagement member is adapted to engage a label and to bias the label 16 toward the first end panel portion first surface 22 to secure the label 16 thereto. It will be understood by one of ordinary skill in the art that other engagement means may be provided for engaging and carrying the label 16 along the first end panel portion first surface 22 without departing from the spirit and scope of the present invention.

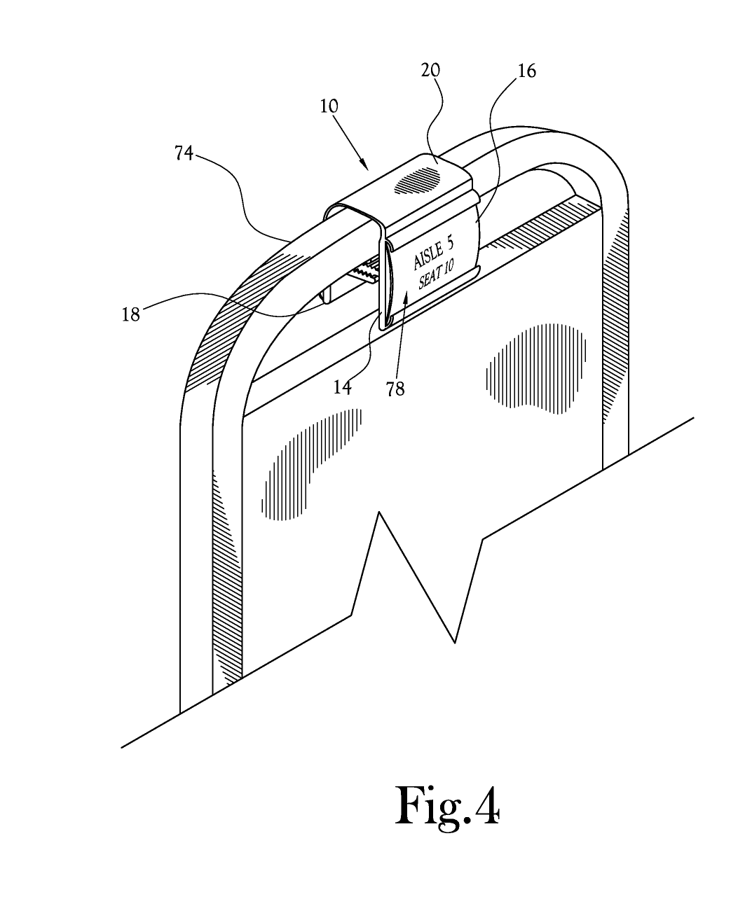

The second end panel portion 18 is defined by the body member 12 opposite the first end panel portion 14. Similar to the first end panel portion 14, discussed above, the second end panel portion 18 defines a substantially rectangular shape having a first surface 36 and an opposite second surface 38 with an outboard end 40 and an opposite inboard end 42. A substantially flexible central portion 20 is defined by the body member 12 and extends generally between the inboard ends 28, 42 of the first and second end panel portions 12, 18. The central portion 20 defines generally a first edge 44 joined along the first end panel portion inboard side 28 and an opposite second edge 46 joined along the second end panel portion inboard side 42. The central portion 20 is adapted to flex about the inboard ends 28, 42 of the first and second end panel portions 14, 18 between an unwrapped, substantially flat configuration in which each of the first and second end panel portions 14, 18 and the central portion 20 cooperate to define a substantially coplanar relationship (see FIG. 1) and a wrapped configuration in which each of the each of the first and second end panel portions 14, 18 and the central portion 20 cooperate to define a substantially semi-tubular shape (see FIGS. 3 and 4).

In the illustrated embodiment, the central portion 20 is defined by a solid sheet of multi-directionally flexible material, such as plastic, rubber or the like, which is integrally formed with each of the first and second end panel portions 14, 18. In this embodiment, the central portion 20 is formed having a thickness less than the thicknesses of the first end panel portion 14, such that the central portion 20 exhibits greater flexibility than the first and second end panel portions 14, 18. Conversely, the first end panel portion 14 is at least semi-rigid to allow the first end panel portion 14 to cooperate with the engaging members 30, 32 to carry and support the label 16. In one embodiment, the first and second end panel portions 14, 18 are formed having sufficient thickness to allow each of the first and second end panel portions 14, 18 to remain at least semi-rigid while the central portion 20 is flexed between the unwrapped and wrapped configurations. In another embodiment, the central portion 20 is defined by a sheet of mono-directionally flexible material, such as corrugated cardboard, slatted sheeting, mono-directionally aligned wooden matting such as “tatami” matting, or the like, which is joined between the inboard ends 28, 42 of the first and second end panel portions 14, 18 in an orientation so as to allow the mono-directionally flexible material to wrap about the first and second end panel portion inboard ends 28, 42. In still another embodiment, the central portion 20 is defined by non-continuous flexible material, such as a plurality of flexible cords, cloth, or the like. In still another embodiment, the central portion 20 is defined by a substantially elongated flexible member, such as an elongated rubber or plastic material, cord, rope, chain, or the like. Those skilled in the art will recognize other materials and configurations suitable for forming the central portion 20, and such materials may be used without departing from the spirit and scope of the present invention.

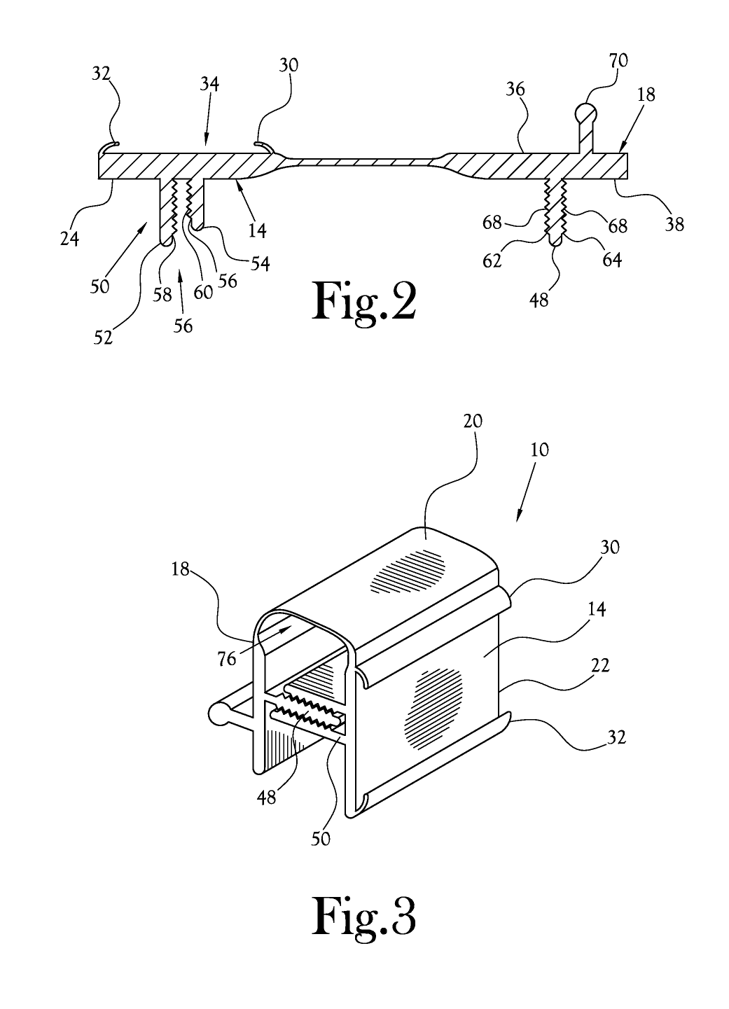

As mentioned above, the central portion 20 is adapted to engage and wrap substantially around a surroundable member of an object such as a handle of a chair. The first and second end panel portions 14, 18 cooperate to define a releasable connector such that the first and second end panel portions 14, 18 are adapted to be releasably fastened to one another to hold the device 10 in the wrapped configuration about the surroundable member. In the embodiment shown in FIG. 2, a post 48 is provided which is anchored to and extends outwardly from the second surface 38 of the second end panel portion 18. A clip 50 is provided along the second surface 24 of the first end panel portion 14 for releasably engaging the post 48. In the illustrated embodiment, the clip 50 is defined by a pair of bifurcated planar members 52, 54 extending substantially outwardly from the first end panel portion second surface 24. The planar members 52, 54 are arranged in a substantially parallel-planar, spaced apart configuration to define a groove 56 therebetween. The post 48 is sized to be received within and mate to the groove 56, thereby forming a releasable connector with the clip 50.

In one embodiment, the clip 50 and the post 48 are each formed with a thickness sufficient to maintain at least semi-rigidity of the releasable connector, in order to limit flexure of the clip 50 and the post 48 to allow the post 48 to remain mated within the groove 56, yet with sufficient flexibility to allow the clip 50 and the post 48 to flex slightly proximate one another to allow selective disconnection of the post 48 from within the groove 56. In the illustrated embodiment, a plurality of internal serrations 60 are defined by opposing inner surfaces 56, 58 of the clip 50. Corresponding outer surfaces 62, 64 of the post 48 define serrations 68 which mate with the internal serrations 60 of the clip 50 in releasable closing fashion, thereby allowing the post 48 to form a more secure connection with the clip 50 when the post 48 is received within the groove 56. However, it will be understood by one of skill in the art that inclusion of the various ridges 60, 68 is not necessary to accomplish the present invention. Furthermore, it will be understood that other releasable connectors exist which are suitable for use to selectively secure the second end panel portion 18 proximate the first end panel portion 14, and such releasable connectors may be used without departing from the spirit and scope of the present invention.

In the illustrated embodiment, a substantially elongated handle 70 is provided along the first surface 36 of the second end panel portion 18 to allow a convenient mechanism by which a user may manipulate the second end panel portion 18 and adjoining central portion 20 between the open and closed position and by which a user may maneuver the second end panel portion 18 to accomplish selective insertion and withdrawal of the post 48 into and out of the groove 56. In one embodiment, the handle 70 is integrally formed with the second end panel portion 18. In another embodiment, the handle 70 is secured proximate the second end panel portion first surface 36. Those skilled in the art will recognize other devices and configurations suitable for allowing a user to manipulate the second end panel portion 18 which may be used without departing from the spirit and scope of the present invention. Furthermore, it will be understood that inclusion of the handle 70 is not necessary to accomplish the present invention.

In several embodiments, the device 10 is formed by extruding a material such as thermoplastic resin, rubber, or other such extrudable material along a linear direction 72. In these embodiments, each of the various features of the device 10 are integrally formed with one another and are defined by a single linear body member formed from the substantially extrudable material. In the illustrated embodiment, the device 10 is defined by a single extruded member having a cross-sectional shape shown in FIG. 2. Accordingly, in the illustrated embodiment, the engaging members 30, 32, the clip 50, the post 48, and the handle 70 each extend substantially parallel to one another along the extruded direction 72 (see FIG. 1) substantially perpendicular to the cross-section illustrated in FIG. 2. The exact ranges of acceptable thicknesses of the various features of the device 10 depend upon the physical properties of the specific material selected to form the device 10. For example, as discussed above, the central portion 20 is generally formed having a thickness less than the thicknesses of the first end panel portion 14 and the second end panel portion 38, respectively, such that the central portion 20 is flexible between the wrapped and unwrapped configuration, while the first end panel portion 14 and the second end panel portion 38 remain at least semi-rigid. In another embodiment, the device 10 is formed by a molded member, such as through an injection-molding process. In other embodiments, the device 10 is assembled through separate components joined by means known to one of ordinary skill in the art.

Referring to FIGS. 3 and 4, in use, the device 10 is positioned in the open configuration with the first end panel portion second surface 24 facing a surroundable member of an object to be labeled, such as a handle portion 74 of a stackable chair. The central portion 20 is flexed toward the wrapped position such that the flexible member wraps about the handle 74. Thereafter, the post 48 is mated with the clip 50, thereby releasably connecting the second end panel portion 18 proximate the first end panel portion 14. In this configuration, the first end panel portion 14, the second end panel portion 18, and the central portion 20 cooperate to define a substantially closed channel 76 which substantially encloses at least a portion of the handle 74. In this configuration, the first surface 22 of the first end panel portion 14 is adapted to carry and display a label 16 proximate the handle 74 of the stackable chair. In the illustrated embodiment, the label 16 is marked with row and seat number identification indicia 78, to designate assigned seating in a configuration of like chairs. However, it will be understood by one of ordinary skill in the art that the device 10 may be used to display labels 16 carrying numerous other indicia without departing from the spirit and scope of the present invention.

From the foregoing description, those skilled in the art will recognize that an device for securing a label proximate a surroundable member, such as a handle of a stackable chair, has been provided which offers advantages over the prior art. The device is structured such that it is capable of carrying and displaying a label proximate a surroundable member absent destructive alteration of the surroundable member and absent excessive tooling of the device or the surroundable member. When secured around a surroundable member of an object such as a handle of a chair, the device is adapted to carry a label in a fixed position proximate the surroundable member such that movement of the label proximate the surroundable member is discouraged, thereby discouraging obscurement of the indicia marked on the label as the chair is repositioned. Moreover, the device, once secured around a surroundable member, is readily removable therefrom, allowing speedy enjoyment of the object absent disruption due to a lengthy and cumbersome label removal process.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative device and methods, and illustrative examples shown and described. Accordingly, departures may be made from such details without departing from the spirit or scope of applicants general inventive concept.

1. (canceled)

2. (canceled)

3. (canceled)

4. (canceled)

5. A device for removably mounting a label on a surroundable surface comprising:
a body member defining a substantially planar geometry, said body member comprising:
a first end panel portion and an opposite second end panel portion, each said end panel portion defining a first surface and an opposite second surface and an outboard side and an opposite inboard side, said first and second end panel portions cooperating to define a releasable connector, at least one of said first and second panel portions including at least one engaging member anchored to and projecting outwardly from said first surface thereof and being adapted to removably secure a label thereto, at least one of said first and second end panel portions defining a pair of engaging members extending along said first surface thereof, said engaging members being adapted to engage a label to secure the label proximate said front surface; and
a central portion interposed between and joined to respective inboard sides of said first and second end panel portions, at least said central portion being flexible for engaging and at least partially wrapping about the surroundable surface;
wherein said releasable connector is defined by a clip anchored to and projecting outwardly from said second surface of said first panel portion and a post anchored to and projecting outwardly from said second surface of said second panel portion, said clip being defined by a pair of planar members extending substantially perpendicular to said first end panel portion second surface, said planar members being configured in a substantially parallel-planar, spaced apart configuration to define a groove therebetween, said planar members defining opposing inner surfaces, at least one of said opposing inner surfaces defining a plurality of substantially parallel serrations, said post being keyed to said serrations and adapted to be received within said groove to establish a releasable connection with said planar members to releasably secure said second end panel portion proximate said first end panel portion when said body member is at least partially wrapped about the surroundable surface to secure said device in removable wrapping relationship to said surroundable surface, wherein said releasable connector is adapted to secure said first end panel portion proximate said second end panel portion when said body member is at least partially wrapped about the surroundable surface to secure said device in removable wrapping relationship to said surroundable surface.

6. The device of claim 5, said each of said engaging members extending along one of said inboard and outboard sides of said at least one of said first and second end panel portions.

7. The device of claim 5, said each of said first and second end panel portions being at least semi-rigid.

8. The device of claim 5, said central portion being defined by a multi-directionally flexible material.

9. The device of claim 5, said second end panel portion defining a handle adapted to allow a user to reposition said second end panel portion proximate said first end panel portion between a wrapped position and an unwrapped position.

10. The device of claim 9, said body member being defined by an integrally formed, linearly extruded member.

11. (canceled)

12. (canceled)

13. (canceled)

14. (canceled)

15. A linearly extruded member for releasably securing a label proximate a surroundable member such as a handle of a chair, said linearly extruded member comprising:
a first portion defining an at least semi-rigid panel having a first surface adapted to carry a label thereon and an opposite second surface, said first portion defining a pair of engaging members overhanging said front surface of said first portion, said engaging members being adapted to engage a label to secure the label proximate said first portion front surface;
a second portion defining an at least semi-rigid panel arranged substantially co-planar to said first portion, said second portion being releasably securable proximate said first portion second surface; and
a flexible third portion joined to and extending between said first and second portions;
whereby when said third portion is secured proximate said first portion second surface, said linearly extruded member defines a substantially closed channel adapted to surround a surroundable member to removably fix said first portion proximate said surroundable member with said first portion first surface facing outwardly from said surroundable member.

16. The device of claim 15, each of said engaging members extending substantially parallel to an extruded direction of said linearly extruded member.

17. The device of claim 15, said first portion second surface defining a first planar member and a second planar member, each of said first and second planar members extending substantially perpendicular to said first portion second surface, said first and second planar members being configured in a substantially parallel-planar, spaced apart configuration to define a groove therebetween, said second portion defining a post adapted to be received within said groove to establish a frictional connection between said first and second planar members.

18. The device of claim 17, said first and second planar members defining opposing inner surfaces, each of said opposing inner surfaces defining a plurality of substantially parallel serrations, said post being keyed to said serrations.

19. The device of claim 18, said second portion defining a handle adapted to allow a user to reposition said second portion proximate said first portion between a wrapped position and an unwrapped position.

20. The device of claim 15, said third portion being defined by a multi-directionally flexible material.
